(19) United States
(12) Patent Application Publication
(10) Pub. No.: US 2025/0181412 A1
(43) Pub. Date: Jun. 5, 2025

(54) RESOURCE DETERMINATION DEVICE, METHOD, AND PROGRAM

(71) Applicant: Nippon Telegraph and Telephone Corporation, Tokyo (JP)

(72) Inventors: Chao WU, Musashino-shi, Tokyo (JP); Shingo Horiuchi, Musashino-shi, Tokyo (JP); Hiroaki Kikushima, Musashino-shi, Tokyo (JP)

(21) Appl. No.: 18/837,815

(22) PCT Filed: Feb. 22, 2022
(86) PCT No.: PCT/JP2022/007259

§ 371 Date: Aug. 12, 2024

(51) Int. Cl. G06F 9/50; G06F 9/455

(52) U.S. Cl. CPC G06F 9/5055; G06F 9/45558

(57) ABSTRACT

A resource determination device according to one embodiment includes: a model storage device that stores a model indicating a relationship among a processing load arranged in a virtual machine, resource arrangement of the virtual machine, and a predicted value of quality when the processing load is arranged in the virtual machine; a determination unit that determines whether or not a predicted value of the quality when it is assumed that a new processing load is arranged in the virtual machine in the model satisfies an appropriate quality requirement; and a control unit that controls change of resource arrangement of the virtual machine such that the predicted value satisfies the appropriate quality requirement when the determination unit determines that the predicted value does not satisfy the appropriate quality requirement.

### TECHNICAL FIELD

Embodiments of the present invention relate to a resource determination device, method, and program.

### BACKGROUND ART

Auto-scaling is relatively often used to control resources of a server computer (refer to Non Patent Literature 1 and 2, for example). In this auto-scaling, adjustment of resources is determined on the basis of a real-time state of a virtual machine (VM) which is an instance, for example, a usage rate of a central processing unit (CPU), or the like.

### CITATION LIST

### Non Patent Literature

Non Patent Literature 1: Lorido-Botran, et, al. A Review of Auto-scaling Techniques for Elastic Applications in Cloud Environments. J Grid Computing 12, 559-592 (2014). Non Patent Literature 2: M. Mao, et al. Auto-scaling to minimize cost and meet application deadlines in cloud workflows, International Conference for High Performance Computing, Networking, Storage and Analysis, 2011, pp. 1-12.

### SUMMARY OF INVENTION

### Technical Problem

In the existing auto-scaling technology described above, since adjustment of resources is determined on the basis of the real-time state of the VM as described above, it is impossible to control resources proactively.

In addition, auto-scaling includes many techniques in consideration of deadline and budget, but does not take requirements of user experience quality into consideration.

Therefore, when auto-scaling is applied to a web conference service, resources cannot be proactively arranged when a plurality of web conferences occur at the same time, and thus there is a possibility of resources being depleted due to a sudden high processing load, and user experience quality deteriorating.

The present invention has been made in view of the above circumstances, and an object thereof is to provide a resource determination device, method, and program capable of appropriately determining a resource according to a state of an instance.

### Solution to Problem

A resource determination device according to one aspect of the present invention includes: a model storage device that stores a model indicating a relationship among a processing load arranged in a virtual machine, resource arrangement of the virtual machine, and a predicted value of quality when the processing load is arranged in the virtual machine; a determination unit that determines whether or not a predicted value of the quality when it is assumed that a new processing load is arranged in the virtual machine in the model satisfies an appropriate quality requirement; and a control unit that controls change of resource arrangement of the virtual machine such that the predicted value satisfies the appropriate quality requirement when the determination unit determines that the predicted value does not satisfy the appropriate quality requirement.

A resource determination method according to one aspect of the present invention is a resource determination method performed by a resource determination device including a storage device that stores a model indicating a relationship among a processing load arranged in a virtual machine, resource arrangement of the virtual machine, and a predicted value of quality when the processing load is arranged in the virtual machine, the method including: determining, by a determination unit of the resource determination device, whether or not a predicted value of the quality when it is assumed that a new processing load is arranged in the virtual machine in the model satisfies an appropriate quality requirement; and controlling, by a control unit of the resource determination device, change of resource arrangement of the virtual machine such that the predicted value satisfies the appropriate quality requirement when the determination unit determines that the predicted value does not satisfy the appropriate quality requirement.

### Advantageous Effects of Invention

According to the present invention, a resource can be appropriately determined according to a state of an instance.

### BRIEF DESCRIPTION OF DRAWINGS

FIG. 1 is a diagram illustrating an application example of a resource determination system according to one embodiment of the present invention.

FIG. 2 is a diagram illustrating an example of input/output data of a web conference quality model.

FIG. 3 is a sequence diagram illustrating an example of a procedure according to vertical scaling by a resource determination device according to the one embodiment of the present invention.

FIG. 4 is a sequence diagram illustrating an example of a procedure according to horizontal scaling by the resource determination device according to the one embodiment of the present invention.

FIG. 5 is a diagram illustrating a specific example of vertical scaling depending on web conference quality.

FIG. 6 is a diagram illustrating a specific example of vertical scaling depending on web conference quality.

FIG. 7 is a diagram illustrating a specific example of vertical scaling depending on web conference quality.

FIG. 8 is a diagram illustrating a specific example of horizontal scaling depending on web conference quality.

FIG. 9 is a diagram illustrating a specific example of horizontal scaling depending on web conference quality.

FIG. 10 is a diagram illustrating a specific example of horizontal scaling depending on web conference quality.

FIG. 11 is a diagram illustrating a specific example of horizontal scaling depending on web conference quality.

FIG. 12 is a diagram illustrating a specific example of horizontal scaling depending on web conference quality.

FIG. 13 is a block diagram illustrating an example of a hardware configuration of the resource determination device according to the one embodiment of the present invention.

### DESCRIPTION OF EMBODIMENTS

Hereinafter, one embodiment according to the present invention will be described with reference to the drawings.

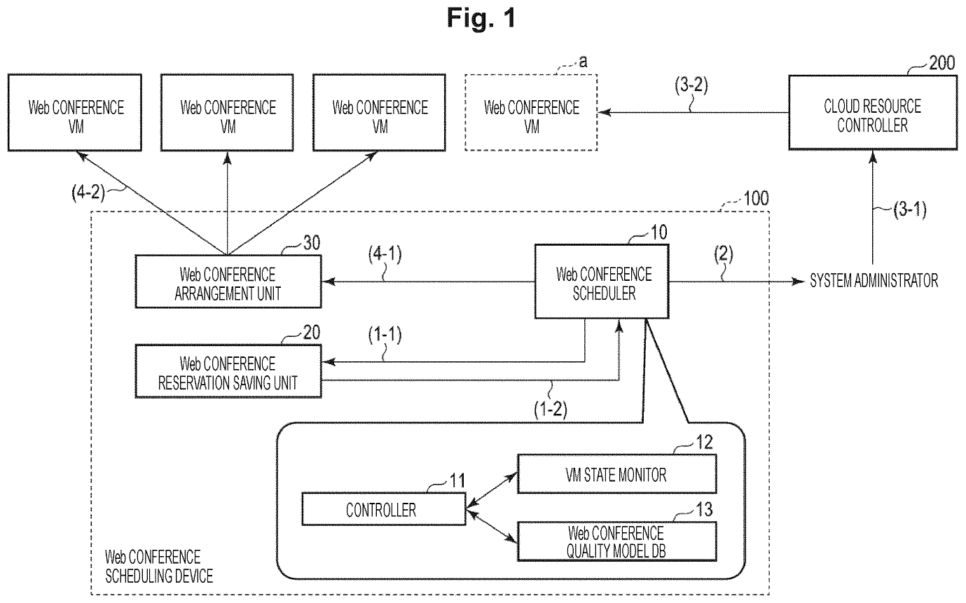

FIG. 1 is a diagram illustrating an application example of a resource determination system according to the one embodiment of the present invention.

As illustrated in FIG. 1, the resource determination system according to the one embodiment of the present invention includes a web conference scheduling device 100 that is a resource determination device, and a cloud resource controller 200.

The web conference scheduling device 100 includes a web conference scheduler 10, a web conference reservation saving unit 20, and a web conference arrangement unit 30. Further, the web conference scheduler 10 includes a controller 11, an instance (VM) state monitor 12, and a web conference quality model database (DB) 13.

In a database (not illustrated) of the web conference reservation saving unit 20, reservation information indicating reservation content of a web conference that has been reserved and has not yet finished, that is, a new web conference, that is, reservation information of a new processing load, is stored. This reservation information includes, for example, identification information (identifier (ID)) assigned to each piece of reservation information, the number of participants scheduled to participate in the reserved web conference, and information on a time zone in which the web conference is scheduled to be held. Information on a finished web conference is deleted from the web conference reservation saving unit 20.

A user who desires to reserve a new web conference can send a web conference reservation request to the web conference scheduler 10 using an interface (not illustrated) connectable to the web conference scheduler 10.

Upon receiving the reservation request, the web conference scheduler 10 stores reservation information related to the request in the web conference reservation saving unit 20 ((1-1) in FIG. 1), and then acquires reservation information including the stored reservation information and indicating reservation content of web conferences that have been reserved and have not yet finished ((1-2) in FIG. 1). This reservation information indicates a processing load (which may hereinafter be referred to as a web conference load) related to a web conference arranged in a VM, for example, information related to the number of participants in the web conference and a scheduled opening time zone.

Upon acquiring the reservation information, the controller 11 of the web conference scheduler 10 inquires of the instance state monitor 12 about a state of each VM which is an instance used for a web conference, for example, a setting status of resources in the VM in which the web conference is arranged, for example, the number of cores of a CPU and a memory capacity, and acquires the information from the inquiry. Here, it is assumed that each VM is a virtual machine operated on a cloud.

The controller 11 inputs the information acquired from the instance state monitor 12 to the web conference quality model in the web conference quality model DB 13. The web conference quality model can receive information indicating a setting status of a resource in a VM in which a web conference is arranged and a processing load related to the web conference arranged in the VM and a web conference assumed to be arranged in the VM and output a predicted value of user experience quality related to the web conference arranged in the VM, and an input/output relationship can be learned in advance.

When the predicted value of the user experience quality output from the web conference quality model does not satisfy predetermined conditions of the user experience quality, the controller 11 recommends that a system administrator adjust the resource of the VM in which the web conference is arranged such that the user experience quality satisfies the aforementioned conditions ((2) in FIG. 1).

At the same time, the controller 11 instructs the web conference arrangement unit 30 to arrange the web conference in a VM which is an arrangement destination of the web conference such that the user experience quality satisfies the aforementioned conditions ((4-1) in FIG. 1).

The system administrator gives an instruction related to resource adjustment by operating the cloud resource controller 200 ((3-1) in FIG. 1).

In accordance with this instruction, the cloud resource controller 200 can start a new VM (refer to reference sign a in FIG. 1) in which the web conference is arranged, or change resources of this VM ((3-2) in FIG. 1).

In accordance with the above instruction, the web conference arrangement unit 30 arranges the web conference in the VM such that the web conference can be started ((4-2) in FIG. 1).

Next, a configuration of the web conference quality model and learning thereof will be described.

The controller 11 of the web conference scheduler 10 acquires, from the instance state monitor 12, (1) a web conference load which is a processing load related to web conferences arranged in a VM and web conferences assumed to be arranged in the VM, and (2) a cloud resource setting which is a setting status of resources in the VM in which web conferences are arranged, and inputs the acquisition result to the web conference quality model as an explanatory variable.

The processing load related to the web conference is, for example, the number of web conferences, the number of participants in the web conferences, the number of publishers participating in the web conferences, the number of subscribers, and the like.

The setting status of resources is, for example, the number of CPUs, a memory amount, and the like provided in the VM that is an instance.

The web conference quality model can output an index representing the quality (user experience quality) of a web conference, that is, a predicted value of the quality of the web conference, as an objective variable, on the basis of the result of the input. By using a regression analysis method, for example, neural-network regression, linear regression, random forest regression, or the like, parameters of this model can be learned such that the input/output relationship becomes appropriate, that is, the predicted value of the quality of the web conference approaches correct answer information.

For example, examples of the index representing the quality (user experience quality) of a web conference include a predicted value of a CPU usage rate in a VM which is an instance in which the web conference is arranged, a jitter, a throughput, and a mean opinion score (MOS), for example.

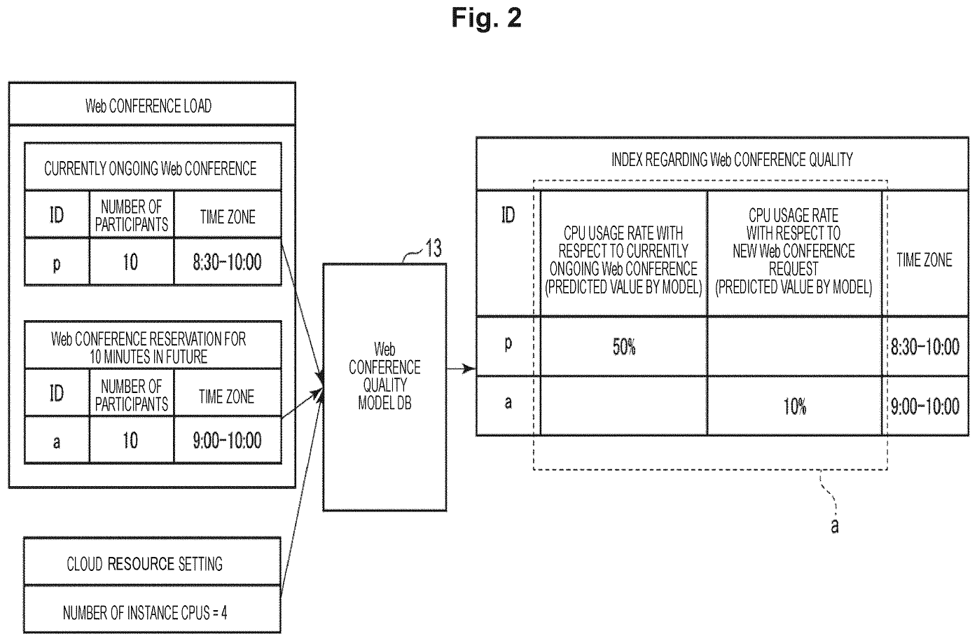

Next, calculation of the index regarding web conference quality using the web conference quality model trained as described above will be described. FIG. 2 is a diagram illustrating an example of input/output data of the web conference quality model. Here, it is indicated that user experience quality is calculated according to reservation of a new web conference.

In the example illustrated in FIG. 2, a web conference load indicated by information input to the web conference model includes (1) a web conference load related to a currently ongoing web conference, and (2) a web conference load related to a web conference reservation for 10 minutes in the future, which is a reservation of a web conference to be started 10 minutes after the current time according to a request for a new web conference (refer to reference sign a in FIG. 2). 10 minutes, which is the time from the current time to the scheduled start time related to the web conference reservation for 10 minutes in the future, can be customized according to the actual operation state of the instance.

The above-described web conference load related to the currently ongoing web conference may include identification information (ID) for uniquely identifying the corresponding web conference, the number of participants of the corresponding web conference, and a time zone from a start time to an end time of the corresponding web conference.

The web conference load related to the web conference reservation for 10 minutes in the future may include identification information for uniquely identifying the corresponding web conference, the number of participants scheduled to participate in the corresponding web conference, and a time zone from the scheduled start time to the scheduled end time of the corresponding web conference.

The cloud resource setting input to the web conference model described above may include the number of CPUs mounted in one VM that is an instance. The currently ongoing web conference is arranged in the one VM.

The aforementioned index related to the quality of a web conference output from the web conference model includes identification information for uniquely identifying the corresponding web conference, a predicted value of a CPU usage rate of the one VM with respect to the currently ongoing web conference, a predicted value of a CPU usage rate of the one VM with respect to a web conference held by a new conference request, and a time zone from the start to the end of each web conference.

In the example illustrated in FIG. 2, when “web conference p” having identification information is “p” is arranged for the one VM, a predicted value of the CPU usage rate of the VM is 50%.

In addition, in the example illustrated in FIG. 2, when it is assumed that “web conference a” having identification information is “a” is newly arranged for the one VM, a predicted value of the CPU usage rate of the VM is 10%.

This “web conference a” is a web conference for which holding in a time zone partially overlapping with the time zone of the “web conference p” has been newly requested.

When the threshold value of the CPU usage rate of the one VM is set to 80%, the sum of the prediction values of the CPU usage rate when it is assumed that the “web conference a” is newly arranged in addition to the “web conference p” with respect to the VM is 60% and does not exceed the threshold value of 80%, and thus the “web conference a” can be arranged in the one VM in which the “web conference p” is currently arranged.

On the other hand, when the predicted value of the CPU usage rate of the VM when it is assumed that the “web conference a” is newly arranged exceeds, for example, 30%, the sum of the predicted values exceeds the threshold value, and thus it is necessary to adjust resources related to the VM that is an arrangement destination.

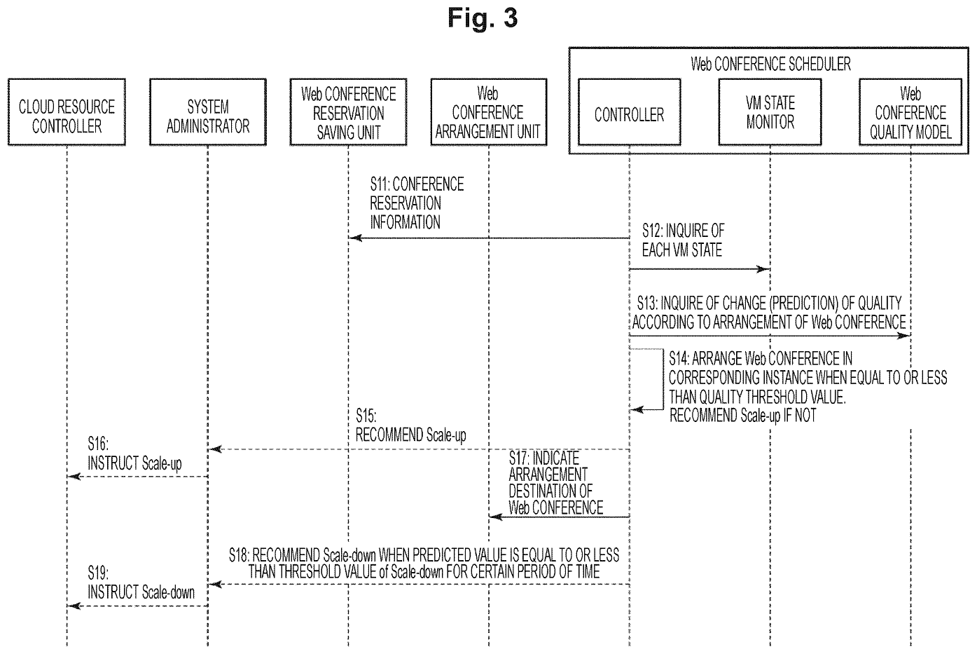

FIG. 3 is a sequence diagram illustrating an example of a procedure according to vertical scaling by a resource determination device according to the one embodiment of the present invention.

In the example illustrated in FIG. 3, a flow of each type of processing when vertical scaling is performed by the web conference scheduler is shown.

First, the controller 11 of the web conference scheduler 10 acquires a currently held web conference and conference reservation information newly requested to be held as the web conference load from the web conference reservation saving unit 20 (S11).

The controller 11 inquires of the instance state monitor 12 about cloud resource setting which is a state of each existing VM in which a web conference has already been arranged, and acquires the cloud resource setting (S12).

By inputting the acquisition results in S11 and S12 to the web conference quality model, the controller 11 inquires about a predicted value of a change in user experience quality when it is assumed that the requested web conference is newly arranged in any existing VM, and acquires an output result from the web conference quality model as the predicted value (S13).

The controller 11 compares the predicted value with a user experience quality threshold value of Scale-up, and when the predicted value does not exceed the threshold value, determines that the requested web conference can be arranged in the corresponding existing instance (VM). In this case, resource adjustment associated with arrangement of the requested web conference is not performed.

On the other hand, when the predicted value exceeds the threshold value, it is determined that vertical scaling, which is adjustment of resources of an instance, is necessary in order to arrange and hold the requested web conference in an existing instance. At this time, the controller 11 recommends Scale-up as vertical scaling to the system administrator (S14 and S15), sets a VM as an arrangement destination of the requested web conference among existing VMs, and instructs the web conference arrangement unit 30 to arrange the requested web conference for the set VM (S16). That is, when it is determined that the prediction value does not satisfy the requirement of appropriate quality, the controller 11 controls a change of resource arrangement of the virtual machine such that the prediction value satisfies the requirement of appropriate quality.

The system administrator instructs the cloud resource controller 200 to perform Scale-up on resources of each VM according to the recommendation from the controller 11 (S17). In accordance with this instruction, the cloud resource controller 200 executes control necessary to perform the above-described Scale-up. By this Scale-up, the resources of the VM are expanded, for example, the number of cores of the CPU is increased.

Furthermore, after execution of the above-described Scale-up, a prediction value of a change in the user experience quality is acquired, for example, at regular time intervals, and when the acquired prediction value is equal to or less than a threshold of Scale-down smaller than the user experience quality threshold of the above-described Scale-up, for example, the controller 11 recommends Scale-down of the instance to the system administrator (S18).

The system administrator instructs the cloud resource controller 200 to perform Scale-down on resources of each VM according to the recommendation from the controller 11 (S19). In accordance with this instruction, the cloud resource controller 200 executes control necessary to perform the above-described Scale-down.

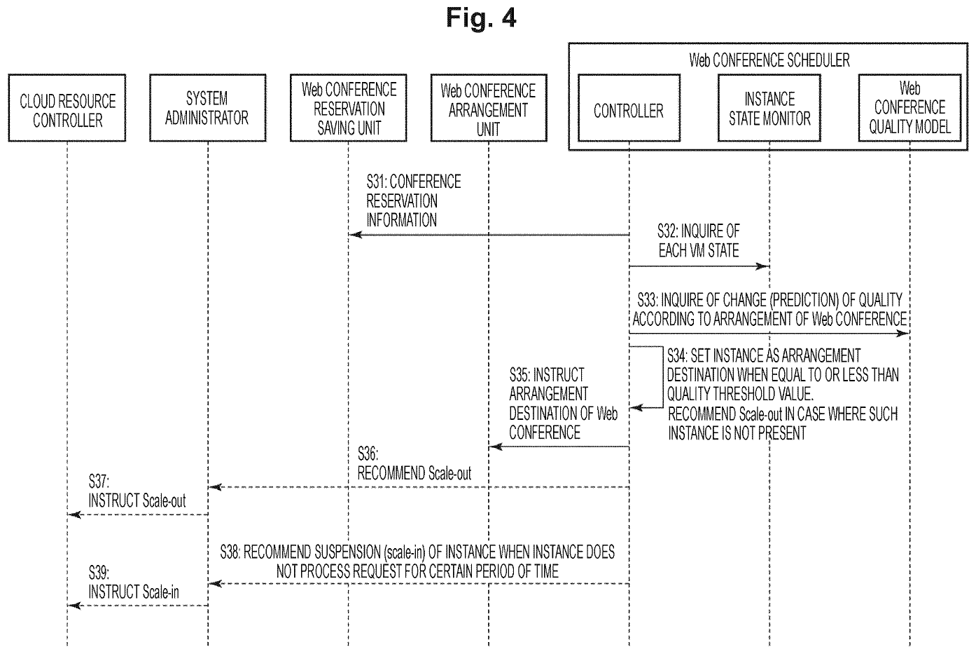

FIG. 4 is a sequence diagram illustrating an example of a procedure related to horizontal scaling by the resource determination device according to the one embodiment of the present invention.

In the example illustrated in FIG. 4, a flow of each type of processing when horizontal scaling is performed by the web conference scheduler is shown.

First, the controller 11 of the web conference scheduler 10 acquires a currently held web conference and conference reservation information newly requested to be held as the web conference load from the web conference reservation saving unit 20 (S31).

The controller 11 inquires of the instance state monitor 12 about cloud resource setting which is a state of each existing VM in which a web conference has already been arranged, and acquires the cloud resource setting (S32).

By inputting the acquisition results in S31 and S32 to the web conference quality model, the controller 11 inquires about a predicted value of a change in user experience quality when it is assumed that the requested web conference is newly arranged in any existing VM, and acquires an output result from the web conference quality model as the predicted value (S33).

The controller 11 compares the predicted value with a user experience quality threshold value of Scale-up, and when the predicted value does not exceed the threshold value, determines that the requested web conference can be arranged in the corresponding existing instance (VM). In this case, resource adjustment associated with arrangement of the requested web conference is not performed.

On the other hand, when the predicted value exceeds the threshold value, it is determined that horizontal scaling, which is adjustment of resources of an instance, is necessary to arrange and hold the requested web conference in an existing instance.

At this time, the controller 11 recommends Scale-out as vertical scaling to the system administrator (S34 and S35), sets a new VM that is different from each existing VM and is an arrangement destination of the requested web conference, and instructs the web conference arrangement unit 30 to arrange the requested web conference in the set VM (S36).

In accordance with the recommendation from the controller 11, the system administrator instructs the cloud resource controller 200 to perform Scale-out on the resources of the VM (S37).

In accordance with this instruction, the cloud resource controller 200 executes control necessary to perform the above-described Scale-out. By this Scale-up, resources of a VM are added, for example, a new VM is added to existing VMs.

In addition, after execution of the above-described Scale-out, the controller 11 accesses the web conference arrangement unit 30 in order to check presence or absence of a web conference arranged in the added VM, and when no web conference is arranged in the added VM for a certain period of time, the controller 11 recommends that the system administrator perform Scale-in for suspending the corresponding VM (S38).

The system administrator instructs the cloud resource controller 200 to perform Scale-in on the resources of the corresponding VM according to the recommendation from the controller 11 (S39). In accordance with this instruction, the cloud resource controller 200 executes control necessary to perform the above-described Scale-in.

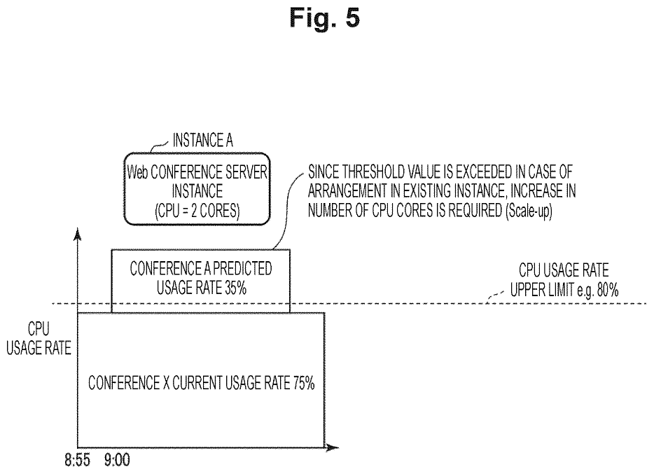

FIGS. 5 to 7 are diagrams illustrating specific examples of vertical scaling depending on web conference quality.

First, in the example illustrated in FIG. 5, an example in which “instance A” which is an existing instance is a VM in which the number of CPU cores is 2, a prediction value of the current CPU usage rate with respect to “conference X” which is an existing web conference arranged in the VM from 8:55 is 75%, and an upper limit of the CPU usage rate in the VM is 80% is shown. This upper limit is a CPU usage rate for satisfying user experience quality.

In the example illustrated in FIG. 5, it is assumed that arrangement of a new web conference “conference A” starting at 9:00 is requested, and a predicted value of the CPU usage rate which increases when it is assumed that this “conference A” is newly arranged in “instance A” is 35%.

In this case, since the overall CPU usage rate when it is assumed that “conference A” is newly arranged in “instance A” is 110% which exceeds the upper limit of 80%, vertical scaling related to “instance A”, in this case, increasing of the number of CPU cores, is necessary, and thus the above-described Scale-up is required.

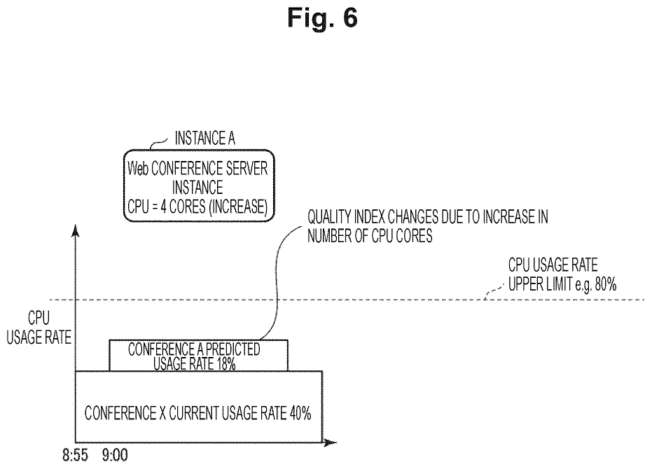

In the example illustrated in FIG. 6, it is assumed that the number of CPU cores of “instance A” is increased from 2 to 4 according to the above-described Scale-up.

In this configuration, it is assumed that a prediction value of the current CPU usage rate with respect to the web conference currently arranged in the VM corresponding to “instance A” decreases from 75% to 40% described above, and a prediction value of the CPU usage rate which increases when it is assumed that “conference A” is newly arranged in “instance A” decreases from 35% to 18% described above.

In this case, since the overall CPU usage rate when it is assumed that “conference A” is newly arranged in “instance A” decreases from 110% to 58% which does not exceed the upper limit of 80%, “conference A” is newly arranged in “instance A”, and this “conference A” can be implemented together with the existing web conference “conference X”.

Then, when the overall CPU usage rate when it is assumed that “conference A” is newly arranged in “instance A” decreases which does not exceed the upper limit according to the above-described Scale-up, a new web conference can be arranged in “instance A”.

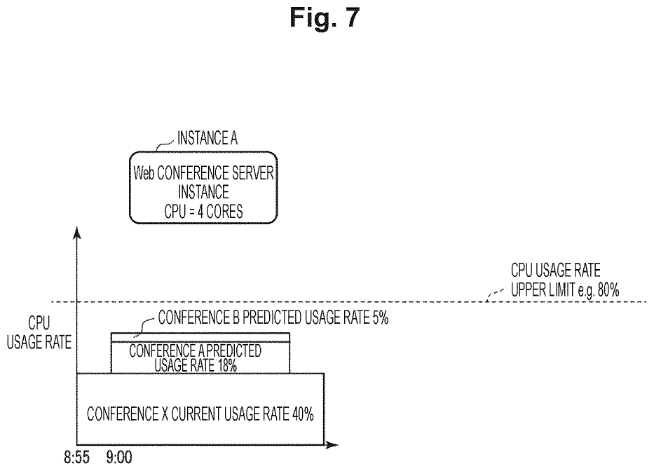

For example, in the example illustrated in FIG. 7, since a predicted value of the CPU usage rate that increases when it is assumed that “conference B” is newly arranged in addition to “conference A” in “instance A” is 5%, and the overall CPU usage rate is 63% which does not exceed the upper limit, “conference B” is newly arranged in “instance A” and this “conference B” can be implemented together with the existing web conference “conference X” and the previously arranged “conference A”.

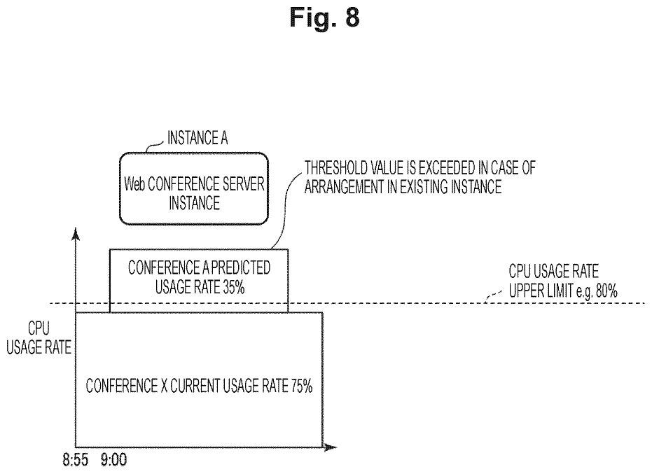

FIGS. 8 to 12 are diagrams illustrating specific examples of horizontal scaling depending on web conference quality.

First, in the example illustrated in FIG. 8, an example in which a prediction value of the current CPU usage rate with respect to an existing web conference “conference X” arranged from 8:55 in a VM which is “instance A” which is an existing instance is 75%, and an upper limit of the CPU usage rate in this VM is 80% is shown.

In the example illustrated in FIG. 8, it is assumed that arrangement of a new web conference “conference A” starting at 9:00 is requested, and a predicted value of the CPU usage rate which increases when it is assumed that this “conference A” is newly arranged in “instance A” is 35%.

In this case, since the overall CPU usage rate when it is assumed that “conference A” is newly arranged in “instance A” is 110% which exceeds the upper limit of 80%, horizontal scaling related to “instance A”, in this case, increasing of the number of CPU cores, is necessary, and thus the above-described Scale-out is required.

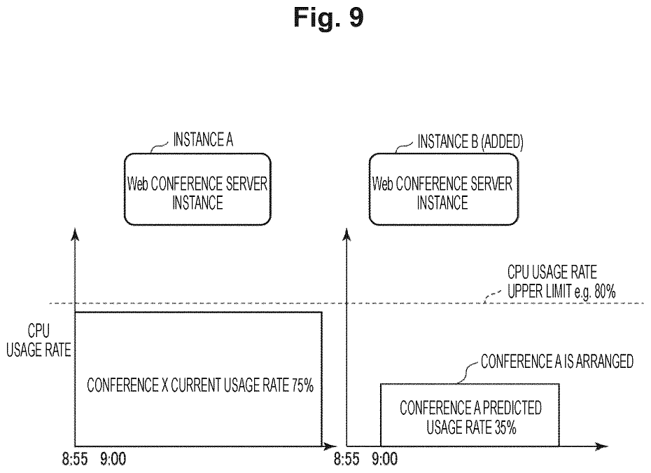

In the example illustrated in FIG. 9, it is assumed that a new “instance B” is added according to the above-described Scale-out.

In this configuration, it is assumed that a prediction value of the CPU usage rate when it is assumed that “conference A” is newly arranged in a VM corresponding to a new “instance B” instead of the existing “instance A” and this “conference A” is newly arranged in “instance B” is 35%.

In this case, since the overall CPU usage rate of “instant A” when it is assumed that “conference A” is newly arranged remains at the above-described 75% which does not exceed the upper limit of 80%, “conference A” is newly arranged in “instance B” and this “conference A” can be implemented together with the existing web conference “conference X” arranged in “instance A”.

Then, according to the above-described Scale-out, a new “instance B” is provided, and the CPU usage rates of “instance A” and “instance B” when it is assumed that “conference A” is newly arranged in this instance have margins with respect to the upper limit, and thus a new web conference can be arranged in each instance.

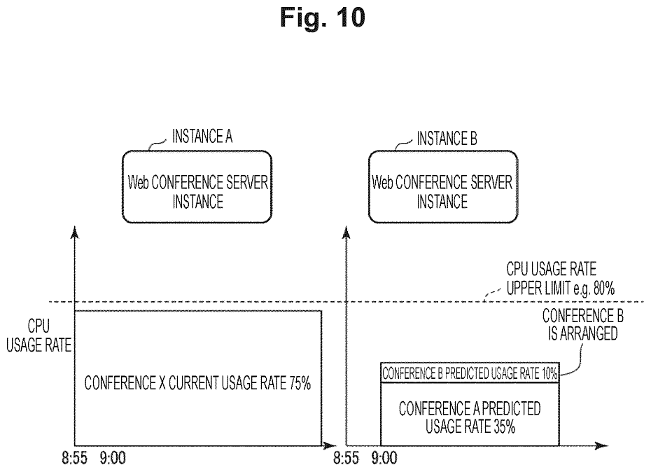

For example, in the example illustrated in FIG. 10, a predicted value of the CPU usage rate when it is assumed that “conference B” is newly arranged in addition to “conference A” in new “instance B” is 10%, and the overall CPU usage rate is 45% which does not exceed the upper limit, and thus “conference B” is newly arranged in “instance B” and this “conference B” can be implemented together with the existing web conference “conference X” and the previously arranged web conference “conference A”.

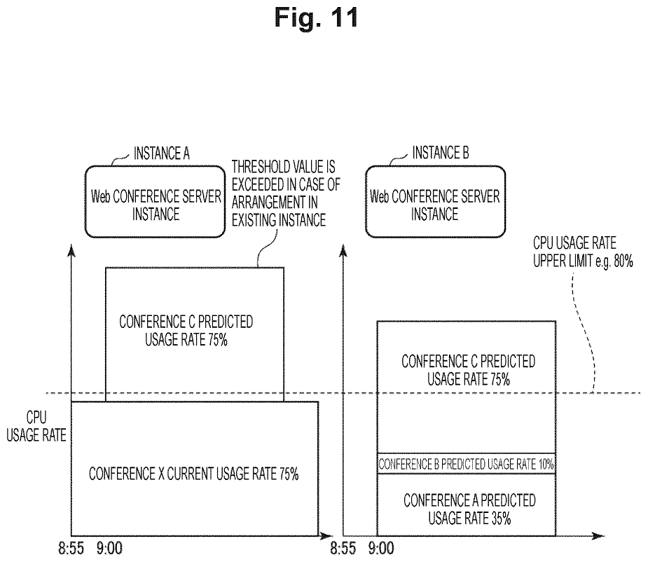

Then, the example illustrated in FIG. 11 shows that a predicted value of the CPU usage rate which increases when it is assumed that a new web conference “conference C” is arranged in “instance A” is 75%, the overall CPU usage rate when it is assumed that “conference A” is newly arranged in “instance A” is 150% which exceeds the upper limit of 80%, a predicted value of the CPU usage rate which increases when it is assumed that “conference C” is newly arranged in “instance B” is 75% above, and the overall CPU usage rate when it is assumed that “conference C” is newly arranged in “instance B” is 120%, which exceeds the upper limit of 80% in a state in which it is assumed that “conference B” is newly arranged in “instance B”, as illustrated in FIG. 10. At this time, in order to perform “conference C”, an additional Scale-out is necessary.

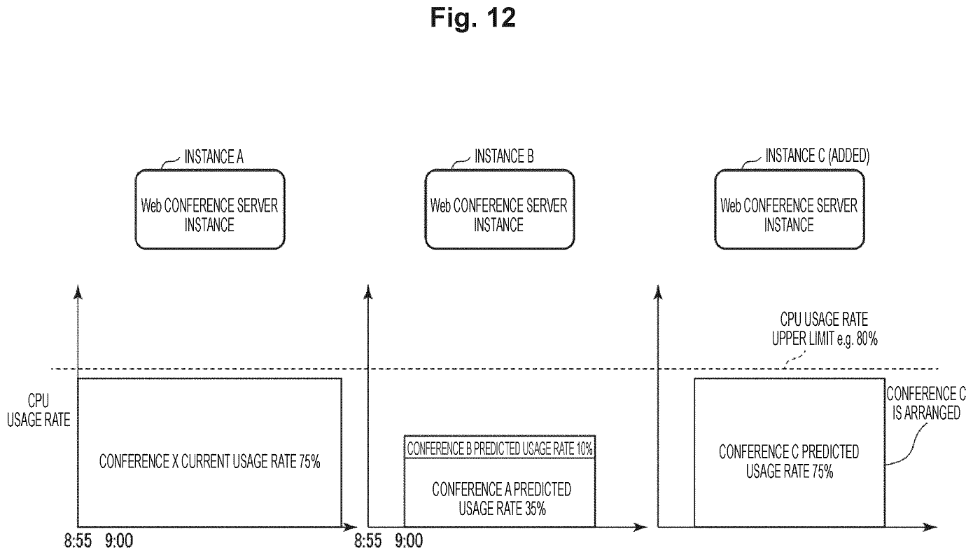

Then, in the example illustrated in FIG. 12, when it is assumed that a new “instance C” is added according to the above-described further Scale-out and the above-described “conference C” is newly arranged in this instance, the overall CPU usage rate in “instance A” to “instance C” does not exceed the upper limit of 80%, and thus “conference C” can be implemented together with the existing web conference “conference X” and the previously arranged web conferences “conference A” and “conference B”.

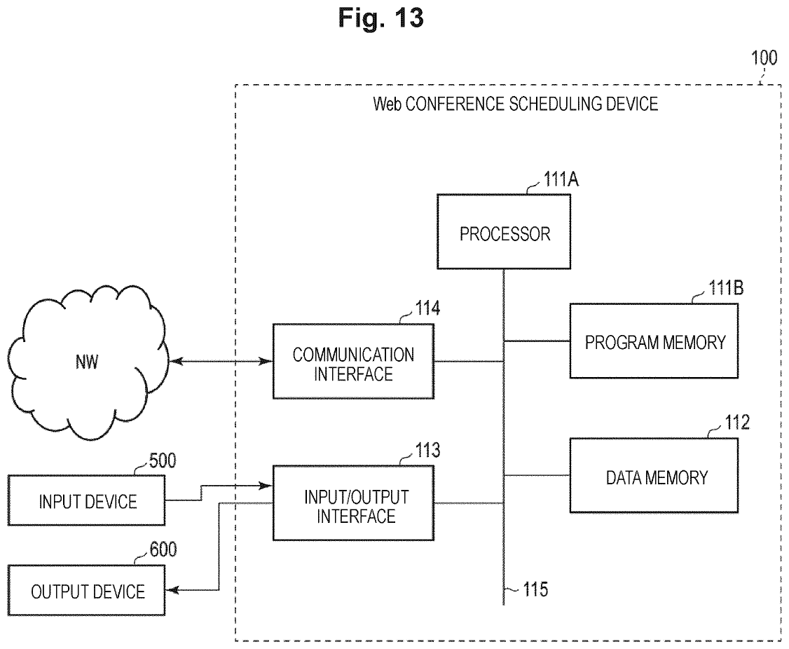

FIG. 13 is a block diagram illustrating an example of a hardware configuration of the resource determination device according to the one embodiment of the present invention.

In the example illustrated in FIG. 13, the web conference scheduling device 100 according to the above-described embodiment is configured as, for example, a server computer or a personal computer, and includes a hardware processor 111A such as a CPU. Then, a program memory 111B, a data memory 112, an input/output interface 113, and a communication interface 114 are connected to the hardware processor 111A via a bus 115. The same applies to the cloud resource controller 200.

The communication interface 114 includes, for example, one or more wireless communication interface units, and can transmit/receive information to/from a communication network NW. As the wireless interface, for example, an interface adopting a low-power wireless data communication standard such as a wireless local area network (LAN) is used.

An input device 500 and an output device 600, which are attached to the web conference scheduling device 100 and used by a user or the like, are connected to the input/output interface 113.

The input/output interface 113 takes in operation data input by a user or the like through the input device 500 such as a keyboard, a touch panel, a touchpad, or a mouse, and performs processing of outputting output data to an output device 600 including a display device using liquid crystal, organic electro luminescence (EL), or the like to display the output data. Note that, as the input device 500 and the output device 600, a device built in the web conference scheduling device 100 may be used, and an input device and an output device of another information terminal that can communicate with the web conference scheduling device 100 via the network NW may be used.

For example, the program memory 111B is, for example, a combination of a non-volatile memory that can be written and read as needed, such as a hard disk drive (HDD) or a solid state drive (SSD), and a non-volatile memory such as a read only memory (ROM) as a non-transitory tangible storage medium, and stores programs necessary to execute various types of control processing and the like according to the one embodiment.

The data memory 112 is, for example, a combination of the above-described non-volatile memory and a volatile memory such as a random access memory (RAM) as a tangible storage medium, and is used to store various types of data acquired and created in the process of performing various types of processing.

The web conference scheduling device 100 according to the one embodiment of the present invention can be configured as a data processing device including a web conference scheduler 10, the web conference reservation saving unit 20, and a web conference arrangement unit 30 illustrated in FIG. 1 as processing function units by software.

Each information storage unit used as a working memory or the like by each unit of the web conference scheduling device 100 can be configured using the data memory 112 illustrated in FIG. 13. However, these configured storage areas are not essential to the web conference scheduling device 100, and may be, for example, areas provided in an external storage medium such as a Universal Serial Bus (USB) memory or a storage device such as a database server arranged in a cloud.

The processing function units in the respective units of the web conference scheduler 10, the web conference reservation saving unit 20, and the web conference arrangement unit 30 can be realized by causing the hardware processor 111A to read and execute a program stored in the program memory 111B. Note that some or all of these processing functional units may be realized by other various formats including an integrated circuit such as an application specific integrated circuit (ASIC) or a field-programmable gate array (FPGA).

In the one embodiment described above, for example, when a model representing the relationship between cloud resources, a processing load of a web conference service, and user experience quality is constructed and a reserved web conference is arranged in a VM, it is determined whether or not an index of user experience is satisfied, and in a case where the index is not satisfied, resources is controlled by horizontal scaling or vertical scaling such that the index is satisfied. Therefore, optimal resources can be determined in consideration of user experience quality.

Furthermore, the method described in each embodiment can be stored in a recording medium such as a magnetic disk (Floppy (registered trademark) disk, hard disk, or the like), an optical disc (CD-ROM, DVD, MO, or the like), or a semiconductor memory (ROM, RAM, flash memory, or the like) as a program (software means) that can be executed by a computer, and can be distributed by being transmitted through a communication medium. Note that a program stored on a medium side also includes a configuration program that causes a computer to configure software means (not only an execution program but also a table and a data structure) to be executed by the computer in the computer. A computer that implements the present device reads a program recorded in a recording medium, constructs a software means by a configuration program according to circumstances, and executes the above-described processing by the operation being controlled by the software means. Note that the recording medium in the present specification is not limited to a recording medium for distribution, and includes a storage medium such as a magnetic disk or a semiconductor memory provided in an apparatus provided inside a computer or connected via a network.

Note that the present invention is not limited to the above embodiments, and various modifications can be made in the implementation stage without departing from the gist thereof. In addition, the respective embodiments may be implemented in appropriate combination, and in that case, a combined effect can be obtained. Furthermore, the above-described embodiments include various inventions, and various inventions can be extracted by a combination selected from a plurality of disclosed constituent elements. For example, even if some components are deleted from all the components shown in the embodiment, if the problem can be solved and the effect can be obtained, the configuration from which the components are deleted can be extracted as the invention.

### REFERENCE SIGNS LIST

100 Web conference scheduling device
200 Cloud resource controller
10 Web conference scheduler
11 Controller
12 Instance state monitor
13 Web conference quality model DB
20 Web conference reservation saving unit
30 Web conference arrangement unit

1. A resource determination device comprising:
a model storage device that stores a model indicating a relationship among a processing load arranged in a virtual machine, resource arrangement of the virtual machine, and a predicted value of quality when the processing load is arranged in the virtual machine;
a determination unit that determines whether or not a predicted value of the quality when it is assumed that a new processing load is arranged in the virtual machine in the model satisfies an appropriate quality requirement; and
a control unit that controls change of resource arrangement of the virtual machine such that the predicted value satisfies the appropriate quality requirement when the determination unit determines that the predicted value does not satisfy the appropriate quality requirement.

2. The resource determination device according to claim 1, wherein
the model is a model in which information indicating a processing load arranged in the virtual machine and resource arrangement of the virtual machine is input as explanatory variables, and a predicted value of quality when the processing load is arranged in the virtual machine is output as an objective variable, and
parameters of the model are updated such that the predicted value of the quality approaches correct answer information.

3. The resource determination device according to claim 1, wherein
the control unit
controls change of the resource arrangement such that performance is expanded without changing the number of virtual machines such that the predicted value satisfies the appropriate quality requirement when the determination unit determines that the predicted value does not satisfy the appropriate quality requirement.

4. The resource determination device according to claim 1, wherein the control unit controls change of the resource arrangement such that the number of virtual machines in which the processing load is arranged is added such that the predicted value satisfies the appropriate quality requirement when the determination unit determines that the predicted value does not satisfy the appropriate quality requirement.

5. The resource determination device according to claim 1, further comprising
a processing load information storage device that stores reservation information of a new processing load requested to be arranged in the virtual machine,
wherein the determination unit
determines whether or not a predicted value of the quality when it is assumed that the processing load indicated by the reservation information stored in the processing load information storage device is arranged in the virtual machine satisfies an appropriate quality requirement.

6. A resource determination method performed by a resource determination device including a storage device that stores a model indicating a relationship among a processing load arranged in a virtual machine, resource arrangement of the virtual machine, and a predicted value of quality when the processing load is arranged in the virtual machine, the resource determination method comprising:
determining, by a determination unit of the resource determination device, whether or not a predicted value of the quality when it is assumed that a new processing load is arranged in the virtual machine in the model satisfies an appropriate quality requirement; and
controlling, by a control unit of the resource determination device, change of resource arrangement of the virtual machine such that the predicted value satisfies the appropriate quality requirement when the determination unit determines that the predicted value does not satisfy the appropriate quality requirement.

7. The resource determination method according to claim 6, wherein the model is a model in which information indicating a processing load arranged in the virtual machine and resource arrangement of the virtual machine is input as explanatory variables, and a predicted value of quality when the processing load is arranged in the virtual machine is output as an objective variable, and
parameters of the model are updated such that the predicted value of the quality approaches correct answer information.

8. A non-transitory computer-readable medium having computer-executable instructions that, upon execution of the instructions by a processor of a computer, cause the computer to function as each unit of the resource determination device according to claim 1.
